(19) United States
(12) Patent Application Publication
(10) Pub. No.: US 2011/0097215 A1
(43) Pub. Date: Apr. 28, 2011

(54) Flexible Solid-State Pump Constructed of Surface-Modified Glass Fiber Filters and Metal Mesh Electrodes

(75) Inventors: Thomas J. O'Shaughnessy, Arlington, VA (US); Brandy J. White, Washington, DC (US)

(73) Assignee: The Government of the United States of America, as represented by the Secretary of the Navy, Washington, DC (US)

(21) Appl. No.: 12/898,358

(22) Filed: Oct. 5, 2010

Related U.S. Application Data
(60) Provisional application No. 61/254,482, filed on Oct. 23, 2009.

(51) Int. Cl. F04B 37/00; F04B 39/16; B01D 35/00; B01D 37/00

(52) U.S. Cl. 417/48; 210/416.1; 2/1; 417/572; 29/888.02; 417/53; 210/767

(57) ABSTRACT

An electroosmotic pump includes first and second electrodes which, during operation of the pump, are maintained at a potential difference of, for example, at least about 10V. A membrane intermediate the first and second electrodes includes fibers of an inorganic oxide, such as glass. A surface of the fibers may be functionalized to increase a charge on the membrane with, for example a silane derivative, such as a trialkoxysilane. A fluid in contact with the membrane is drawn through the membrane without the need for moving parts.

This application claims the benefit of U.S. Provisional Application Ser. No. 61/254,482, filed Oct. 23, 2009, entitled MODIFIED GLASS FIBER FILTERS AS THE BASIS OF A SOLID-STATE, FLEXIBLE PUMP, the disclosure of which is incorporated herein in its entirety, by reference.

### BACKGROUND

The exemplary embodiment relates to fiber-based membranes suitable for solid state pumps based on the principles of electroosmotic flow. It finds particular application in conjunction with glass fiber membranes in which the fibers are surface modified to influence the electroosmotic flow in such pumps, and will be described with particular reference thereto. However, it is to be appreciated that the present exemplary embodiment is also amenable to other like applications.

Electroosmotic (EO) flow, which is sometimes referred to as electrokinetic flow, occurs when a porous material is placed between two electrodes and an applied voltage creates an electrical double layer. The ions in solution forming one side of the electrical double layer are pulled toward the opposing electrode, dragging water molecules through the pores of the material. Electroosmotic pumps are being developed for microfluidic applications based on their ability to produce relatively high flow rates with no moving parts. In addition, EO pumps are being incorporated as a layer in fuel cells to remove water accumulating at the cathode while using only a minimal amount of the cell's power output (see, for example, Buie, C. R., et al., “Water management in proton exchange membrane fuel cells using integrated electroosmotic pumping,” Journal of Power Sources 161, 191 (2006)). Other potential applications for EO pumps include drug delivery devices (see, for example, Chen, L. X., Choo, J. B., Yan, B., “The microfabricated electrokinetic pump: a potential promising drug delivery technique,” Expert Opinion on Drug Delivery 4, 119 (2007)) and liquid chromatography (see, for example, Chen, L. X., Ma, J. P., Guan, Y. F., “An electroosmotic pump for packed capillary liquid chromatography,” Microchemical Journal 75, 15 (2001)).

Typically, EO pumps are manufactured from silica beads packed in a channel (see, Borowsky, J., Lu, Q., Collins, G. E., “Electroosmotic Flow-Based Pump for Liquid Chromatography on a Planar Microchip,” Sensors and Actuators B 131, 333 (2008)), from porous glass or silicon (see, Wallner, J. Z., Nagar, N., Friedrich, C. R., Bergstrom, P. L., “Macro porous silicon as pump media for electro-osmotic pumps,” Physica Status Solidi 204, 1327 (2007)), or other porous materials, such as aluminum oxide membranes (Miao, J., et al., “Micropumps Based on the Enhanced Electroosmotic Effect of Aluminum Oxide Membranes,” Advanced Materials 19, 4234 (2007)). These materials (or in the case of packed channels, structures) are typically rigid, producing a fixed pump structure.

### REFERENCES

The following references, the disclosures of which are incorporated herein in their entireties, by reference, are mentioned: U.S. Pat. No. 6,056,860, entitled SURFACE MODIFIED ELECTROPHORETIC CHAMBERS, by Amigo, et al.; U.S. Pat. No. 6,776,911, entitled METHODS FOR SURFACE MODIFICATION OF SILICA FOR USE IN CAPILLARY ZONE ELECTROPHORESIS AND CHROMATOGRAPHY, by Citterio, et al.; U.S. Pat. No. 6,537,437, entitled SURFACE-MICROMACHINED MICROFLUIDIC DEVICES, by Galambos et al.; U.S. Pat. No. 6,942,018, entitled ELECTROOSMOTIC MICROCHANNEL COOLING SYSTEM, by Goodson, et al.; U.S. Pat. No. 7,185,697, entitled ELECTROOSMOTIC MICROCHANNEL COOLING SYSTEM, by Goodson, et al.; U.S. Pat. No. 7,316,543, entitled ELECTROOSMOTIC MICROPUMP WITH PLANAR FEATURES, by Goodson, et al.; U.S. Pat. No. 6,488,831, entitled CHEMICAL SURFACE FOR CONTROL OF ELECTROOSMOSIS BY AN APPLIED EXTERNAL VOLTAGE FIELD, by Hayes; U.S. Pat. No. 7,231,839, entitled ELECTROOSMOTIC MICROPUMPS WITH APPLICATIONS TO FLUID DISPENSING AND FIELD SAMPLING, by Huber, et al., U.S. Pat. No. 7,086,839, entitled MICRO-FABRICATED ELECTROKINETIC PUMP WITH ON-FRIT ELECTRODE, by Kenny, et al.; U.S. Pat. No. 6,861,274, entitled METHOD OF MAKING A SDI ELECTROOSMOTIC PUMP USING NANOPOROUS DIELECTRIC FRIT, by List, et al.; U.S. Pat. No. 7,297,246, entitled ELECTROKINETIC PUMP, by Patel; U.S. Pat. No. 7,134,486, entitled CONTROL OF ELECTROLYSIS GASES IN ELECTROOSMOTIC PUMP SYSTEMS, by Santiago, et al.; U.S. Pub No. 20090008255, entitled ARRANGEMENT FOR GENERATING LIQUID FLOWS AND/OR PARTICLE FLOWS, METHOD FOR PRODUCING AND OPERATING SAID ARRANGEMENT AND USE OF THE LATTER, by Andreas, et al.; U.S. Pub No. 20080179188, entitled METHODS, COMPOSITIONS AND DEVICES, INCLUDING ELECTROOSMOTIC PUMPS, COMPRISING COATED POROUS SURFACES, by Nelson, et al.

### BRIEF DESCRIPTION

In accordance with one aspect of the exemplary embodiment, an electroosmotic pump includes first and second electrodes and a membrane, intermediate the first and second electrodes, which includes inorganic oxide fibers. A source of a potential difference is connected with the electrodes, which during operation of the pump, provides an electric field between the electrodes.

In accordance with another aspect of the exemplary embodiment, a membrane for an electroosmotic pump includes inorganic oxide fibers functionalized with a silane derivative.

In accordance with another aspect of the exemplary embodiment, a method for forming an electroosmotic pump includes disposing a membrane comprising inorganic oxide fibers between first and second electrodes and connecting a source of electrical potential to the electrodes, whereby a polar liquid in contact with one of the electrodes is drawn through the membrane by a charge on the membrane.

### BRIEF DESCRIPTION OF THE DRAWINGS

FIG. 1 is a side sectional view of an electroosmotic pump in accordance with one aspect of the exemplary embodiment;

FIG. 2 is an exploded perspective view of the pump of FIG. 1;

FIG. 3 illustrates functionalizing agents after covalent bonding to a surface of a glass fiber;

FIG. 4 illustrates a filtration system employing an electroosmotic pump in accordance with another aspect of the exemplary embodiment;

FIG. 5 illustrates an article of clothing incorporating an electroosmotic pump in accordance with another aspect of the exemplary embodiment;

FIG. 6 is a plot showing flow rates for various filters when incorporated into an electroosmotic pump;

FIG. 7 is a plot showing flow rates and pumping efficiencies (flow rate/power) for pumps using silane derivatives of varying hydrophobicity to modify the glass fiber surface of Millipore GF/F filters;

FIG. 8 shows flow rates as a function of applied voltage for pumps using aminopropyltriethoxysilane (APS) or 3-mercaptopropyltriethoxysilane (MPS) to modify the glass fiber surface of Millipore GF/F filters;

FIG. 9 shows pumping efficiencies of the pumps of FIG. 8 as a function of applied voltage;

FIG. 10 shows flow rates and pumping efficiencies for 0.1 and 1.2 cm² area filters, indicating that increased surface area of filters, combined with mesh electrodes, results in increase efficiency and the ability to operate at substantially lower voltages; and

FIG. 11 illustrated the effect of membrane thickness on the flow rate of water through the membrane.

### DETAILED DESCRIPTION

Aspects of the exemplary embodiment relate to a membrane, a solid solid-state pump based on the principles of electroosmotic flow comprising the membrane, and methods of making and use of such a pump for moving water or other ionizable liquids.

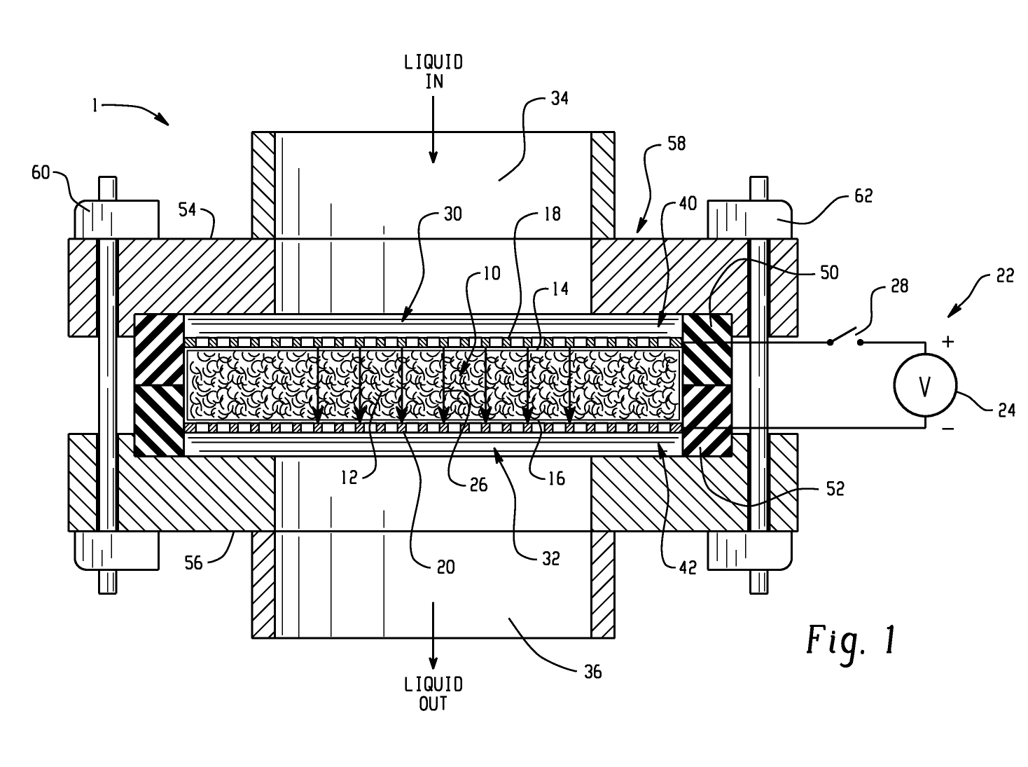

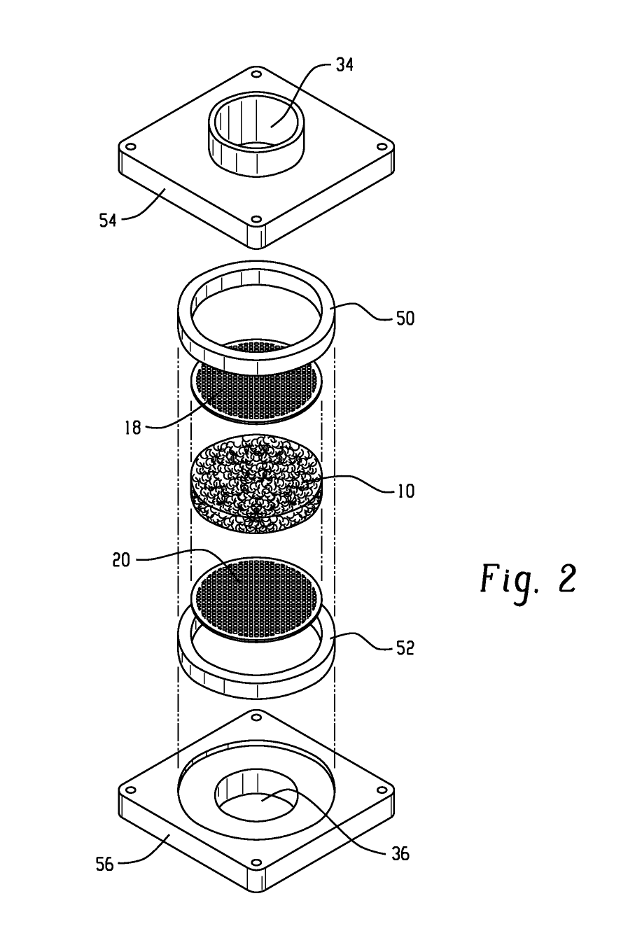

FIG. 1 is a schematic side sectional view of an exemplary electroosmotic pump 1 (not to scale) in accordance with one aspect of the exemplary embodiment. FIG. 2 shows the components of the pump in perspective view. The pump 1 includes an electroosmotic membrane or filter 10 formed from fibers 12, which may be non-woven (entangled fibers), as shown, or woven. The membrane thickness is enlarged in FIG. 1 for clarity. The exemplary membrane 10 is a flexible membrane, allowing it to conform to various shapes. The fibers 12 define pores between them which extend completely through the electroosmotic membrane 10 between opposed sides 14, 16 of the membrane. Adjacent the sides of the membrane, and optionally directly in contact therewith, are first and second electrodes 18, 20. While the exemplary electrodes 18, 20 and membrane 10 are planar, both the membrane and electrodes can be flexible, allowing other configurations, such as convex or irregular shapes of membrane and electrodes. The exemplary electrodes 18, 20 are in the form of a mesh as shown in FIG. 2. This aids in generating a uniform field across the membrane. In one embodiment, the electrodes are bonded to the filter material 10, for example, with an adhesive or stitched to it using a non-conductive stitching thread.

The electrodes 18, 20 are connected by wires of an electrical circuit 22 with a DC voltage source 24, such as a high voltage power supply or a battery. An electric field 26 is generated between the electrodes, which passes through the membrane 10. The field may be varied by changing the voltage across the electrodes. Voltages of from about 10 to 10,000 volts may be used, depending on the size of the pump 1, membrane type, liquid to be pumped, and flow rate desired. Voltages of about 30-800 V and a current of about 5 mA can produce flow rates of 0.3-0.8 ml/min. water, for example, through small, unfunctionalized membranes of about 0.1 cm² in surface area and about 300-1000 μm in thickness, with higher flow rates being achievable when the membrane is functionalized. For some applications, lower flow rates may be satisfactory. The pump 1 can be switched on and off by means of a switch 28 in the electrical circuit 22.

The electrodes 18, 20, can be formed from an electrically conductive material, such as platinum, silver, gold, carbon, stainless steel, combination thereof, or the like. The electrically conductive material may be in the form of a coating on another material. The electrodes may each be shaped as a porous body, such as a wire mesh, or wires, sheets, or layers of an electrically conductive material. As an example, electrodes are formed from platinum-coated molybdenum wire mesh or gold wire mesh. The electrodes 18, 20 can be flexible, allowing the mesh to flex along with the electroosmotic membrane 10 and maintain contact therewith. For example, wire mesh having a wire diameter of about 0.01-1 mm may be used. The mesh size can be relatively large. For example, providing a mesh screen with 40-80% open area and apertures of 0.1-1 mm, provides large pores through the mesh which allow for free flow of liquid therethrough. For a flexible electroosmotic pump, placing the glass fiber filter material 10, which is flexible with a consistency similarity to fabric, between two mesh screens that are also flexible (e.g., formed from gold wire of 0.06 mm wire diameter, 82×82 wire/inch, aperture with 0.25 mm, 65% open area) serving as electrodes 18, 20 provides a pump 1 that has the flexibility of a fabric. The electrode mesh may have a maximum thickness of about 10-100 μm, e.g., about 60 μm.

The pump 1 defines a pump chamber 30 configured for containing a polar liquid 32, such as water or an aqueous solution containing ions therein. The electroosmotic membrane 10 and electrodes 18, 20 are disposed within the chamber. Liquid enters the chamber through an inlet 34, adjacent one side 14 of the electroosmotic membrane 10 and exits the chamber, after passing through the membrane, through an outlet 36, adjacent the other side 16 of the membrane. The chamber has inlet and outlet regions 40, 42, which are spaced by the membrane 10. Liquid 38 is drawn through the electroosmotic membrane 10 from one region 40 of the chamber to the other region 42 by electroosmotic flow. In particular, the mobile ions in the layer associated with the net fixed charge on the electroosmotic membrane 10 move through the membrane 10 as a result of the applied potential, carrying with them water and/or other components of the liquid.

In the pump 1 shown in FIG. 1, the chamber is sealed by gaskets 50, 52 in contact with the inlet and outlet walls 54, 56 of the pump containment vessel 58. The assembly is held in place by clamps 60, 62. As will be appreciated, the chamber arrangement shown is for illustrative purposes only and other chamber configurations are also contemplated.

By “electroosmotic,” it is meant that the membrane 10 induces fluid flow therethrough under an applied voltage. The fibers 12 of the electroosmotic membrane 10 may be formed from silica or other oxide material, in particular, one which is capable of being functionalized to modify the surfaces of the fibers. In the exemplary embodiment, the fibers are primarily formed from an inorganic oxide, e.g., at least 51% by weight of one or more functionalizable inorganic oxides, e.g., at least 70 wt.% inorganic oxide. Examples of functionalizable inorganic oxide materials include silica, alumina, zirconia, and combinations thereof. The fibers may be formed by a sintering or binding process. In one embodiment, the fibers are glass fibers. As used herein, “glass fibers” are fibers which are primarily formed from silica, such as soda-glass fibers and quartz fibers, and are substantially amorphous in character. Glass fibers are particularly useful due to their flexibility. For example, the glass fibers of the membrane, prior to surface modification, can be at least 50 or 60 wt % silica, e.g., at least 70 wt % silica, or up to 90 or 100 wt % silica. In one embodiment, the glass fibers are less than 85% silica. While in the exemplary embodiment all of the fibers of the membrane are glass fibers, the membrane may contain a mixture of fibers, e.g., a mixture of at least 50 wt. % glass fibers, with the balance formed from other materials. For example, the glass fibers may be combined with fibers which are primarily formed from ceramic oxides other than silica. The fibers 12 of the membrane may be surface modified, as described in further detail below. The fibers of membranes formed from glass fibers or alumina, for example, carry a net negative charge, which facilitates functionalization.

The membrane 10 may comprise a compressed mass of entangled fibers which defines pores between the fibers. The membrane 10 can be formed, for example, from a commercially available filter material, such as those supplied by Whatman and Millipore. Such filters are available in a range of pore sizes (average pore diameter of pathways between the fibers), e.g., from about 0.2-3 μm, with the pore size distribution being fairly heterogeneous. Pore size does not appreciably affect pump efficiency within this range. In some cases, such filters may be patterned to increase regularity of the pore size. The commercial filters are available in range of thicknesses, such as from about 200 to 700 μm. When a thicker membrane is desired, two, three, or more such filters can be stacked on top of each other to provide, for example, a membrane of up to about 2000 μm in thickness.

In some embodiments, the membrane 10 is at least 100 μm in thickness in order to provide an adequate surface area of the membrane for sufficient surface charge to be available to draw the liquid through the membrane. In one embodiment, the membrane is at least 200 μm in thickness, and in one specific embodiment, at least 600 μm in thickness.

On average, the fibers have a length which is at least ten times the fiber diameter.

The fibers 12 can be functionalized by reaction with a functionalizing agent that is capable of modifying the surface charge on electroosmotic membrane 10. The reaction of the fibers with the functionalizing agent may be performed before or after forming the fibers 12 into the membrane 10. Suitable functionalizing agents are those capable of covalently bonding with silicon (or aluminum, or zirconium) of the membrane to form immobilized, e.g., covalently bonded, functionalizing groups on the surface of the fibers.

The functionalizing agent can be selected to give the surfaces of the membrane fibers a net positive or negative charge. In general, if the filter surface has a net negative charge, liquid flow is from the positive electrode 20 towards the negative electrode 18. If the filter surface has a net positive charge, then liquid flow is from the negative electrode 18 towards the positive electrode 20.

Exemplary functionalizing agents include silane derivatives such as siloxanes, particularly alkoxysilanes, such as trialkoxysilanes, examples of which are shown in TABLE 1 below. Such compounds have three alkoxy groups attached to silicon. The alkoxy groups can be independently selected from C1-C20 alkoxy groups, such as methoxy, ethoxy, propoxy, and the like, with shorter chains, e.g., C6 alkoxy or less, allowing closer packing of the functionalizing agent on the surface. The fourth group attached to the silicon can be selected to give the glass or other ceramic oxide a selected surface charge or interaction character. Some groups provide the oxide fibers with a negative charge while others provide a positive charge to the oxide fibers. Groups can also be selected to change the wetting character of the surface, for example, fluorinated groups tend to make the surface hydrophobic. The choice of the fourth group may depend on the liquid to be pumped through the membrane 10. In general, the charge generated on the fiber surface may be opposite to that of the largest ionized or ionizable species in the liquid 32 to be pumped. This provides for an increase the effectiveness of pumping.

By way of example, four classes of trialkoxysilane are illustrated in TABLE1: a) alkyl, b) alkenyl, c) halogenated, e.g., fluorinated alkanes, and d) methacrylates. Exemplary alkyl groups a) include linear C2-C20 alkyls, such as ethyl, propyl, butyl, hexyl, etc. Exemplary alkenyl groups b) include linear C3-C20 alkenyls, such as vinyl, butynyl, and the like. Exemplary fluorinated alkyls c) include linear alkyl chains with substituted with from 1-40 fluorine groups. Exemplary methacrylates d) may include a C1-C20 unbranched or branched chain linking the methacrylate functionality to the silicon. The alkyl silane derivatives may be may be functionalized, e.g., with a thiol group e) or sulfonate. A small amount of branching of the alkyl or alkenyl group in a), b), c), d), e) is contemplated.

In most of the examples in TABLE 1, the functionality is provided at the terminal end of the fourth group, although additionally, or alternatively, functionality may be provided elsewhere on the chain. Additionally, the carbon chain may be substituted within it with nitrogen, oxygen, or the like. The functionalizing agents may have more than one type of functionality in the fourth group, such as methacrylate, hydroxyl, and amine, in the case of N-(3-Methacryloxy-2-hydroxypropyl)-3-aminopropyltriethoxysilane.

The exemplary silane functionalizing agents are all monomers, having a single silicon atom. While oligomers, such as dimers and trimers of the exemplary silanes are contemplated (two or three silicon atoms), polymers having more than 5 repeat units of one of the exemplary silanes or mixture thereof, such as polysiloxanes, are avoided as they do not tend to exhibit reaction with the ceramic oxide fiber surface. Additionally, for ease of reaction, the silane derivative is one which is liquid at reaction temperature, e.g., is liquid at 80° C. or less, e.g., at 60° C. or less. Trialkoxysilanes, for example, react with the oxide of the fiber through elimination of alcohol to form a covalent bond.

TABLE 1
Exemplary Functionalizing Agents
a) Alkanes

| | |
|---|---|
| 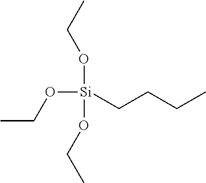 | Butyltriethoxysilane |
| 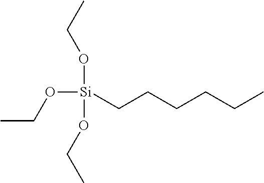 | Hexyltriethoxysilane |
| 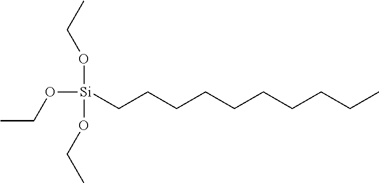 | Decyltriethoxysilane |
| 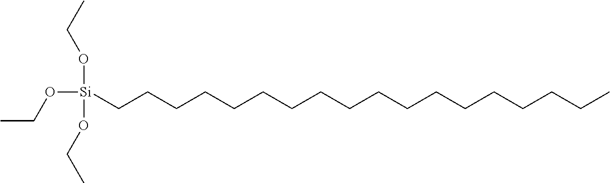 | Octadecyltriethoxysilane |

b) Alkenes

| | |
|---|---|
| 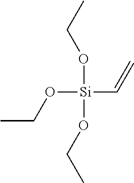 | Vinyltriethoxysilane |
| 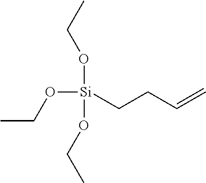 | Butenyltriethoxysilane |
| 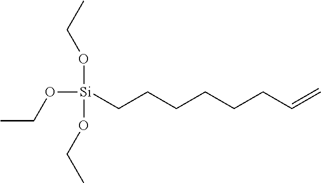 | Octenyltriethoxysilane |

c) Fluorinated

| | |
|---|---|
| 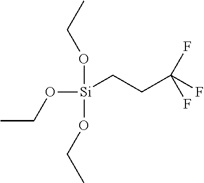 | (3,3,3-trifluoropropyl)triethoxysilane |
| 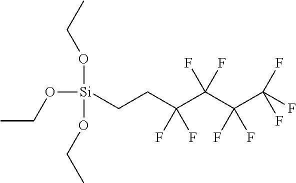 | Nonafluorohexyltriethoxysilane |
| 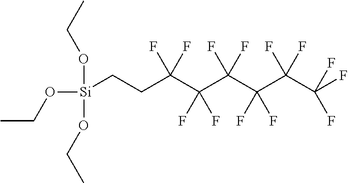 | Perfluoroalkylethyltriethoxysilane |
| 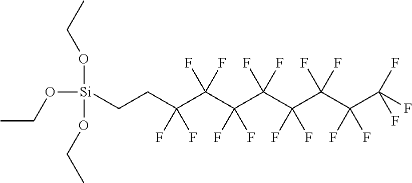 | (Heptadecafluoro-1,1,2,2- tetrahydrodecyl)triethoxysilane |

d) Methacrylate

| | |
|---|---|
| 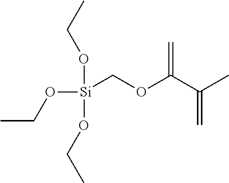 | Methacryloxymethyltriethoxysilane |
| 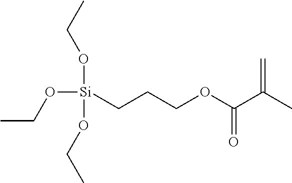 | Methacryloxypropyltriethoxysilane |
| 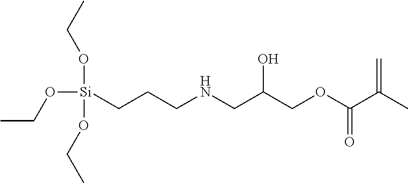 | N-(3-Methacryloxy-2-hydroxypropyl)-3- aminopropyltriethoxysilane |

e) Thioalkanes

| | |
|---|---|
| 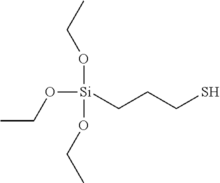 | 3-mercaptopropyltriethoxysilane |
| 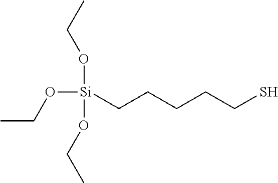 | 3-mercaptobutyltriethoxysilane |

The exemplary fluorinated alkanes, as exemplified in c), provide varying degrees of oleophobicity (reduced wetting by oil, rather than water). The methacrylate groups, as exemplified in d), provide sites at which hydrogen bonds can be formed. 3-aminopropyltriethoxysilane and 3-mercaptopropyltriethoxysilane (MPS) provide charged groups. The silanes with alkane functionality, exemplified in a), tend to provide a hydrophobic character to the oxide surface. Combinations of alkoxysilanes can be used to provide different types of functionality. The size of the functionalizing agent can be selected so that it does not appreciably reduce the pore diameter. The functionalizing agent can also be selected to attract the largest ion in the liquid to be pumped.

While triethoxysilanes, in particular, provide a fast reaction with a glass surface without requiring a catalyst, the functionalizing agent is not limited to those suggested herein. In general, any functionalizing agent capable of covalently bonding to the fiber surface can be used. For some functionalizing agents, a catalyst may be used to assist in the functionalizing reaction.

A process of functionalizing the ceramic oxide fibers may proceed as follows. First, the membrane 10 (or the fibers 12 themselves) may be washed to remove surface impurities which may interfere with the chemistry. Various methods for cleaning fibers and commercial filters are known, such as a base bath, piranha etch (a mixture of sulfuric acid and hydrogen peroxide), or hydrogen peroxide.

For example, the fibers (or preformed filter) are incubated in the selected cleaning liquid for a period of time, then washed with deionized water, and then dried. A solution of the silane derivative or mixture thereof to be used as the functionalizing agent is prepared in a suitable solvent. The exemplary silane derivatives are liquids which readily disperse in a non-polar solvent, such as toluene, anhydrous methanol, or tetrahydrofuran, and other dry solvents. The silane can be present at from about 0.5-10% by weight of the solution. In non-polar solvents, the reaction can proceed uncatalyzed at ambient temperatures (˜17-30° C.), although temperatures of from about 15-80° C. can be used, with the reaction generally proceeding faster at higher temperatures. In other embodiments, the reaction can be base- or acid-catalyzed, using similar temperatures. For example, acid catalysis may be performed using hydrochloric or nitric acid at a concentration of about 0.01-1N in a polar solvent such as water or an alcohol, such as methanol, ethanol, or propan-1-ol. Base catalysis can be carried out using a hydroxide, such as sodium, potassium, or ammonium hydroxide, at from 0.01-1N in a polar solvent such as water or an alcohol, such as methanol, ethanol, or propan-1-ol.

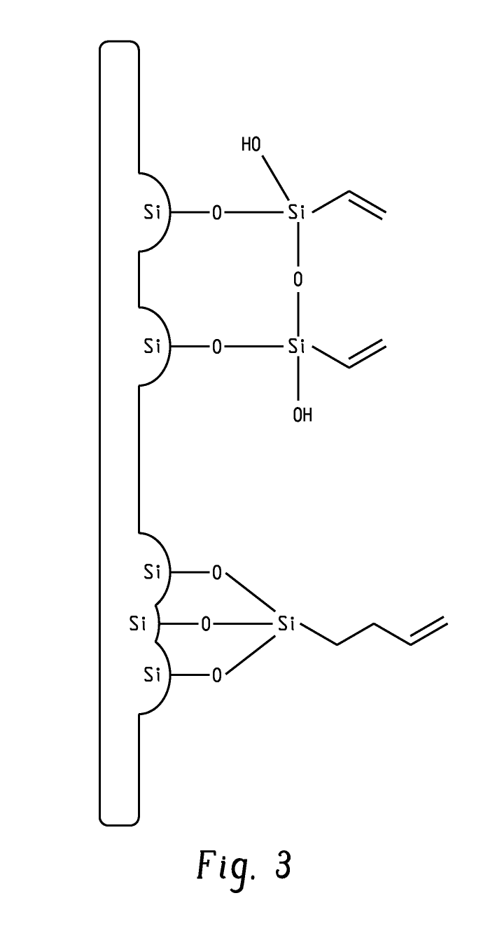

Whether catalyzed or not, the reaction is essentially the same, with the functionalizing agent reacting with the surface of the filter fibers resulting in the elimination of alcohol and oxygen bound to silicon or aluminum on the glass surface. The functionalizing agent molecules each provide a tail which extends from the surface of the fibers, as illustrated in FIG. 3, where the results of reaction with two functionalizing agents are shown.

The fibers 12 may be agitated in the solvent to ensure even coverage of the silane derivative. The silane derivative may be present in the solvent at a concentration of, for example, at least 0.1 wt % of the solution, e.g., about 0.5-10% by weight of the solution, such as about 2 wt %. The concentration of the fibers in the solution is not critical, and can be added, for example, at from 1-1000 g/liter of solution. The functionalizing agent can be used at a ratio of about 60 milligrams/gram of fiber. Filters can typically be functionalized using between 565 μmol/g and 56 mmol/g (moles of siloxane per gram of glass).

After the reaction, excess solution is washed from the functionalized fibers 12 with toluene or deionized water and the fibers/filter dried. The drying may be performed at a sufficient temperature to ensure that any residual silane derivative reacts with the ceramic oxide, e.g., at about 60° C.-1500°.

In some embodiments, further modification of the functionalized glass or other ceramic oxide fibers can be achieved by washing the functionalized fibers, before or after drying, in a suitable solution, such as an acidic solution to achieve higher protonation. For example, aminopropyltriethoxysilane (APS)-modified fibers can be exposed to acidic solutions (e.g., acetate buffer) to provide a more fully-protonated surface (referred to herein as APS+). Treatment of thiol terminated silane modified fibers, such as those functionalized with 3-mercaptopropyltriethoxysilane (MPS), with a peroxide, such as hydrogen peroxide (e.g., at 90° C.) provides terminal sulfonate groups by oxidation of the thiol groups.

An exemplary standard method of preparation of functionalized membranes 10 is given by way of example: Glass fiber filters are first cleaned using a basic solution consisting of 10% potassium hydroxide in methanol. The filters are submerged in an excess of the base bath and incubated for 45 minutes. The solution is then poured off and the filters are rinsed with purified water (e.g., reverse-osmosis purified (RO) water or water for injection (WFI) quality water) and dried overnight at 110° C. Filters can be stored at this point until needed.

The cleaned glass fiber filters are then functionalized by placing one or two filters in a 50 mL polypropylene tube and adding 25 mL of the functionalizing solution. They are then incubated for an hour and a half at room temperature or above, rinsed in toluene, and dried overnight at 110° C.

Further functionalization, such as protonation or peroxide reaction, can follow or be performed before drying.

The exemplary surface-modified filters can provide an increased pumping efficiency, measured as

$$\frac{flow rate}{power consumed} ,$$

as compared with unmodified filters. In one embodiment, the efficiency of the pump 1 is at least 10% greater than a flow rate of the pump without the functionalization for a given liquid, such as water. As will be appreciated, while some functionalizing agents may yield a pump 1 with a lower efficiency, e.g., in the case of water as the liquid 32, as compared to a pump with unfunctionalized fibers, the efficiency may be higher for liquids other than pure water, depending on the ions in the liquid.

Additionally, the type of surface modification of the fibers can be selected to change the direction of flow, as compared with an unmodified membrane 10.

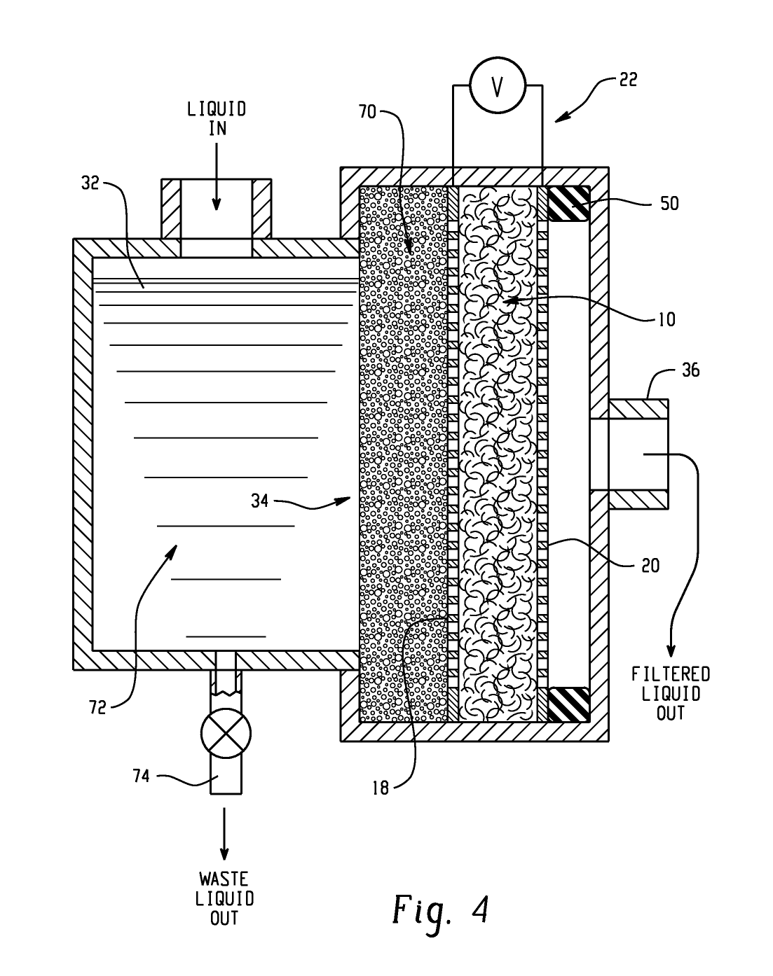

The electroosmotic pump 1 is not limited to the design shown in FIG. 1 and can be adapted to a variety of applications. With reference to FIG. 4, where similar elements are accorded the same numerals, a filtration system which employs the exemplary electroosmotic pump 1 is shown. The filtration system includes a filter membrane 70 which is a partially permeable membrane configured for filtering a liquid medium 32, such as water, to remove impurities, such as particles, e.g., dirt and microorganisms, and/or a selected chemical species or multiple species, such as soluble salts, e.g., sodium chloride. The exemplary electroosmotic pump 1 serves to pull the water through the filter membrane 70, towards an outlet 36, leaving the filtered impurities behind the filter membrane in a collection vessel 72, from where the impurities can be drained off through a vessel outlet 74, periodically. Various partially permeable membrane materials can be used for the filter membrane 70. In the case of a desalination system for example, where the filtered species are primarily sodium and chloride ions, for example, an organized carbon nanotube layer could be used for the filter membrane 70 (see, Formasiero, Park, Holt, Stadermann, et al. “Nanofiltration of electrolyte solutions by sub-2 nm carbon nanotube membranes” (2008) NSTI Nanotech 2, 106-109; and Formasiero, Park, Hold, Stadermann, et al. “Ion exclusion by sub-2-nm carbon nanotube pores” (2008) PNAS 105, 17250-17255).

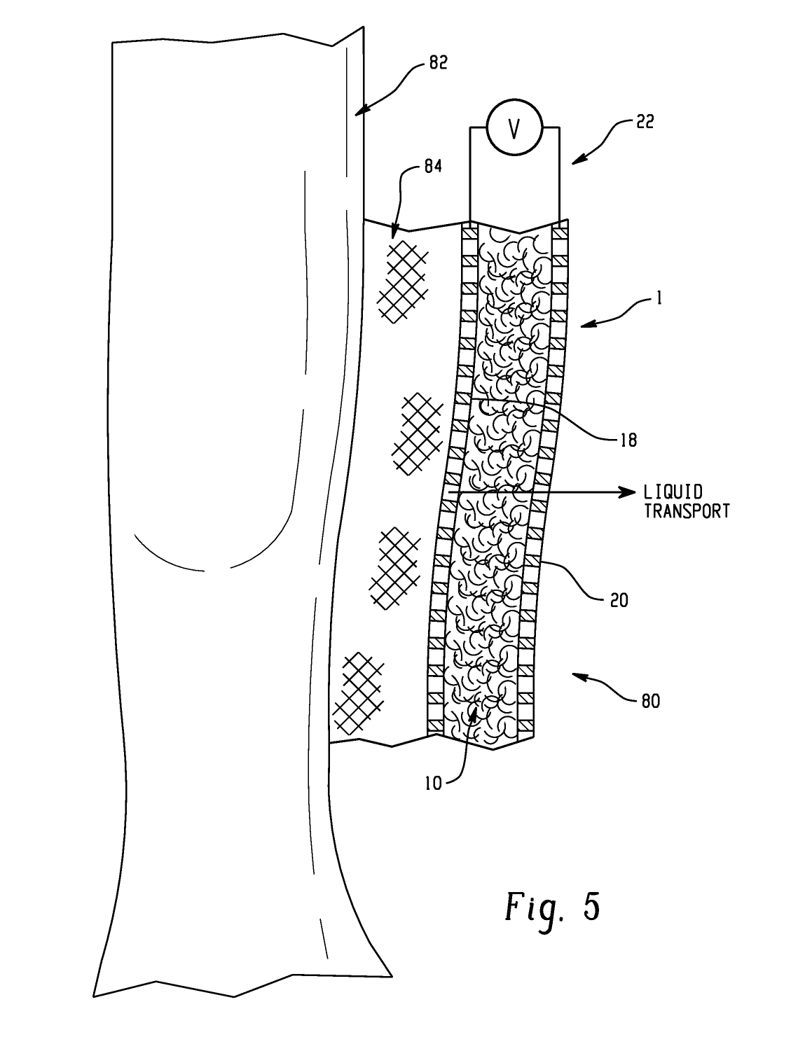

FIG. 5 illustrates another application for the exemplary electroosmotic pump 1. In this embodiment, the pump 1 is incorporated into an item of clothing 80. The item of clothing, such as a one piece protective suit, is shaped to fit the body 82 of a person. The clothing may be formed from a fabric layer 84, which is designed to provide a barrier which inhibits the ingress of harmful species, such as radiation, chemical or biological species, such as warfare agents, and the like. The fabric layer 84 is moisture permeable to allow the person to remain relatively dry within the suit. Such materials, however, often are slow to transport sweat away from the body. The exemplary pump 1 is positioned exterior to, and may be in direct contact with, the fabric layer 84 to actively pull the liquid through the layer 84. For such applications, a relatively low flow rate is adequate, allowing for a low voltage to be applied across the electrodes. The fabric layer 84, or an intermediate layer (not shown), may serve to shield the human body from any stray currents from the electrodes. For such applications, a flexible membrane 10 and flexible electrodes 18, 20 allow the pump 1 to adapt to the contours and movement of the body 82. As will be appreciated, the clothing 80 may include two or more such pumps 1, which may be powered by the same or separate power supplies 24, e.g., carried by the person.

As the examples in FIGS. 4 and 5 show, the exemplary electroosmotic pump 1 has unique characteristics that render it useful for a variety of applications. For example, the flexible materials used offer a low pressure method for driving desalination or a flexible pumping layer for use in driving flow through decontaminating materials. The electroosmotic pump 1 may also find application, particularly at the micron scale, for lab-on-a-chip type applications, for example, when it is desirable to remove liquid from a surface at which a reaction occurs. Functionalization of the glass fiber membrane 10 allows the development of materials that support more energy efficient water transport.

One advantage of the functionalized membrane 10 is that the resulting pump can simply comprise a surface-modified glass fiber filter 10 sandwiched between two mesh electrodes 18, 20. This provides a solid-state pump (having no moving parts) with the flexibility of a fabric. The resulting pump design can be used in applications such as self-cleaning or self-drying fabric, or as the driving force for a water purification membrane. In addition, the flexible nature of the pump allows for designs to place a pump into difficult locations, where standard pumps would not readily fit.

Traditional electroosmotic pumps that rely on packed beds or porous materials can be fashioned into static irregular shapes to fit odd sized locations, however, electrode placement in these cases can be non-optimal. Because the electrodes in the exemplary pump flex along with and maintain position with the glass fiber membrane, the exemplary electrodes are always positioned against and parallel to the filter which results in an optimal electrical field, maximizing efficiency.

Without intending to limit the scope of the exemplary embodiment, the following examples describe methods for making the exemplary pump and results obtained.

### EXAMPLES

In the following examples, commercial filters were first cleaned using a basic solution consisting of 10% potassium hydroxide in methanol. The filters were submerged in an excess of the base bath and incubated for 45 minutes. The solution was then poured off and the filters were rinsed with reverse-osmosis purified (RO) water and dried overnight at 110° C. Filters were stored at this point until needed.

Glass fiber filters were functionalized by placing two filters in a 50 mL polypropylene tube and adding 25 mL of the functionalization solution. They were then incubated for an hour and a half, rinsed in toluene, and dried overnight at 110° C. Treatment of APS modified filters was accomplished through exposure to acidic (acetate buffer) solutions to provide a more fully protonated surface. Treatment of MPS filters using hydrogen peroxide at 90° C. was used to provide sulfonate groups upon oxidation of the thiol groups.

### Example 1

### Comparison of Glass Fiber Filters for Electroosmotic Flow

A small plastic pump chamber, analogous to that illustrated in FIGS. 1 and 2, except in that single wire platinum coated molybdenum electrodes 18, 20 were used in place of a mesh. The chamber was manufactured to hold a membrane 10 in the form of a glass fiber filter or stack of such filters between two rubber o-rings 50, 52 and bring the platinum-coated molybdenum electrodes 18, 20 into close contact with the filter(s). The exposed region of the filter 10 was in the shape of a circle with a surface area of 0.1 cm² (radius=0.18 cm). The pump chamber 30 had sufficient volume to allow gas bubbles generated at the electrodes 18, 20 by electrolysis to dissociate from the electrodes without interfering with flow during the course of the experiment.

The pump chamber 30 was placed in-line with a Sensirion ASL1600-20 flow sensor in a closed loop. A Stanford Research Systems PS350 high voltage power supply 24 was used to apply a 500 volt potential across the filter material 10. The PS350 outputs an analog signal corresponding to the current output by the power supply. This signal was sampled using a MiniDigi 1A USB data acquisition device and pClamp v9 software, both from Axon Instruments. During each experiment, both flow rate and current were sampled at a rate of 100 Hz. The fluid 32 being pumped was WFI water for cell culture obtained from Gibco. Power consumption was calculated as the applied potential (500 V) multiplied by the average current recorded over the testing interval.

Five types of glass fiber filters 10 from Millipore (APFA, APFB, APFC, APFD, APFF) and three types from Whatman (GF/A, GF/D, GF/F) were tested for their ability to support electroosmotic flow without surface modification. These commercial glass fiber filters were cleaned using a base solution. The filters ranged in thickness from 230-700 μm and had pore sizes ranging from 0.7-2.7 μm (Table 2). In all cases, the filters 10 were found to support electroosmotic flow with the flow direction going from the positive electrode 18 through the filter 10 towards the negative electrode 20, indicating that the glass fiber surfaces were negatively charged.

TABLE 2
Characteristics of the Whatman and Millipore filters

| | | Thickness | | Weight | Weight |
|---|---|---|---|---|---|
| Mfr. | Filter | (μm) | Pore Size(μm) | (g/m²) | (g/cm³) |
| Whatman | GF/A | 260 | 1.6 | 53 | 20.4 |
| | GF/D | 680 | 2.7 | 120 | 17.6 |
| | GF/F | 420 | 0.7 | 75 | 17.9 |
| Millipore | APFA | 230 | 1.6 | 55 | 23.9 |
| | APFB | 700 | 1 | 140 | 20.0 |
| | APFC | 240 | 1.2 | 52 | 21.7 |
| | APFD | 470 | 2.7 | 120 | 25.5 |
| | APFF | 380 | 0.7 | 75 | 19.7 |

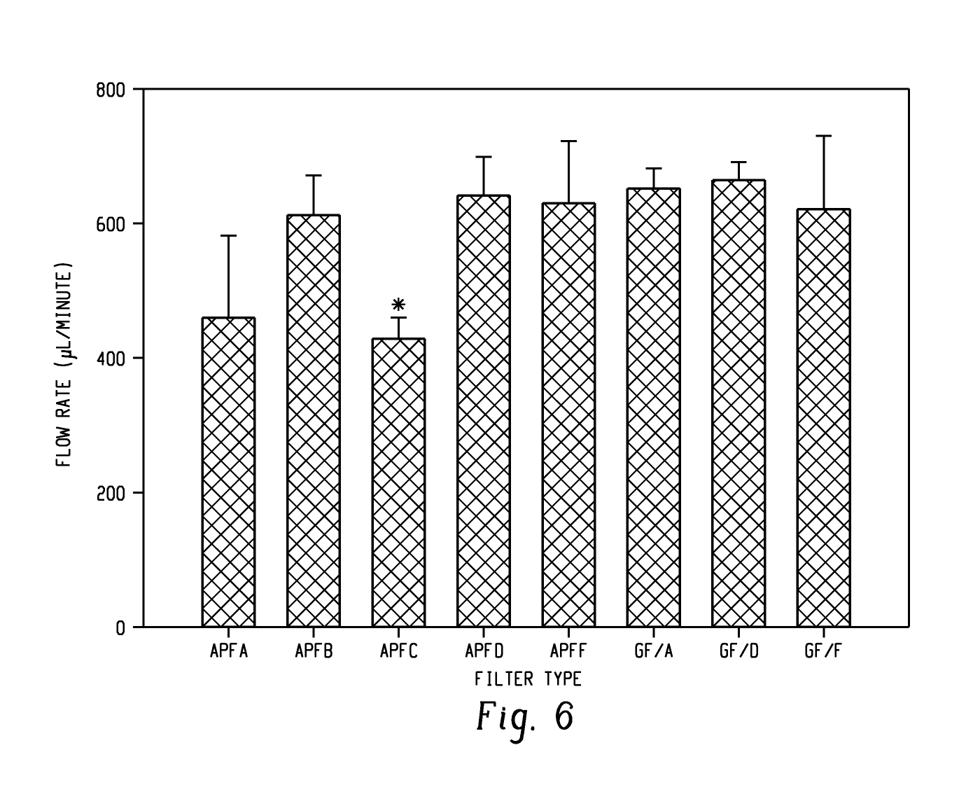

FIG. 6 shows the results obtained, with the mean±standard deviation (STD) for the first three minutes of flow at a potential of 500V (Average of 3 runs). Flow was from the positive to the negative electrode, indicating that the surfaces of the glass fibers were negatively charged. As determined by one-way ANOVA, all filters produced statistically similar flow rates with the exception of the Millipore APFC filter, which was slower than the other filter types. Since the remaining filters performed almost identically, the Whatman GF/F filter (0.7 μm pore size; 420 μm thick) was arbitrarily selected for surface modification experiments.

### Example 2

### Comparison of the Effects of Hydrophobicity of Surface Modified Fibers

Surfaces of the glass fibers of Whatman GF/F filters were modified to make them more hydrophobic, to determine the effect of surface hydrophobicity on the electroosmotic flow. The cleaned glass fiber filters were treated as follows. A solution of a selected functionalizing agent (3.11 g vinyltriethoxysilane (VTS), 3.57 g butenyltriethoxysilane (BTS), or 3.08 g octenyltrimethoxysilane (OTS)) in 4.5 g ethanol and 2.02 g 0.032 N hydrochloric acid was stirred for 20 mins at room temperature. Ethanol (3.6 g) was added to 1.7 g of the silane solution and 1.2 mL of the resulting mixture was used to soak a 47 mm Whatman GF/F glass fiber filter. The filter was then cured at 60° C. for a minimum of 16 hours. As a control, cleaned GF/F glass fiber filters without surface modification were prepared.

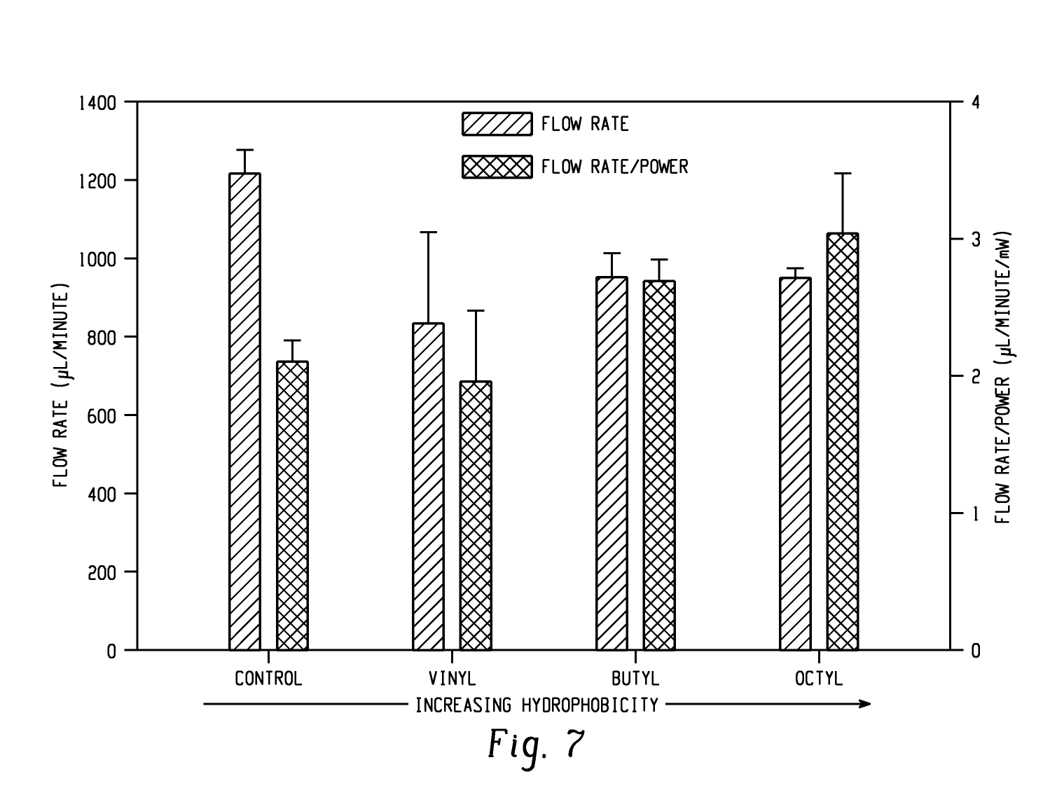

The Whatman GF/F filters treated with increasingly hydrophobic compounds (VTS, BTS, OTS in order of increasing hydrophobicity) were placed in a pump chamber 30 then tested for flow rate and power consumption as described above. The results are shown in FIG. 7. While the flow rate was lower for all three hydrophobic surfaces than for the control, only the least hydrophobic surface was significantly different from the control filters. However, when the flow rate was considered in relation to the power consumed, there was a trend of increasing pumping efficiency with increasing hydrophobicity. The most hydrophobic membrane (OTS-functionalized) was determined to be statistically different from the control via one-way ANOVA and represents an increase in pumping efficiency of approximately 44%.

### Example 3

### Effect of Different Functionalizing Agents

Glass fiber membranes were surface-modified to contain several charged functional groups. Specifically, Whatman GF/F filters were functionalized, using methods similar to those above, respectively with 3-mercaptopropyltriethoxysilane (MPS) to provide thiol groups and with 3-aminopropyltriethoxysilane (APS) to provide amine groups on the glass fiber surfaces. Neither the MPS nor APS surface groups carry a charge in their native states. Some of the MPS surfaces were further modified with hydrogen peroxide in order to produce negatively charged sulfonate groups (surfaces designated MPS−). Some of the APS surfaces were protonated to provide APS+ modified surfaces.

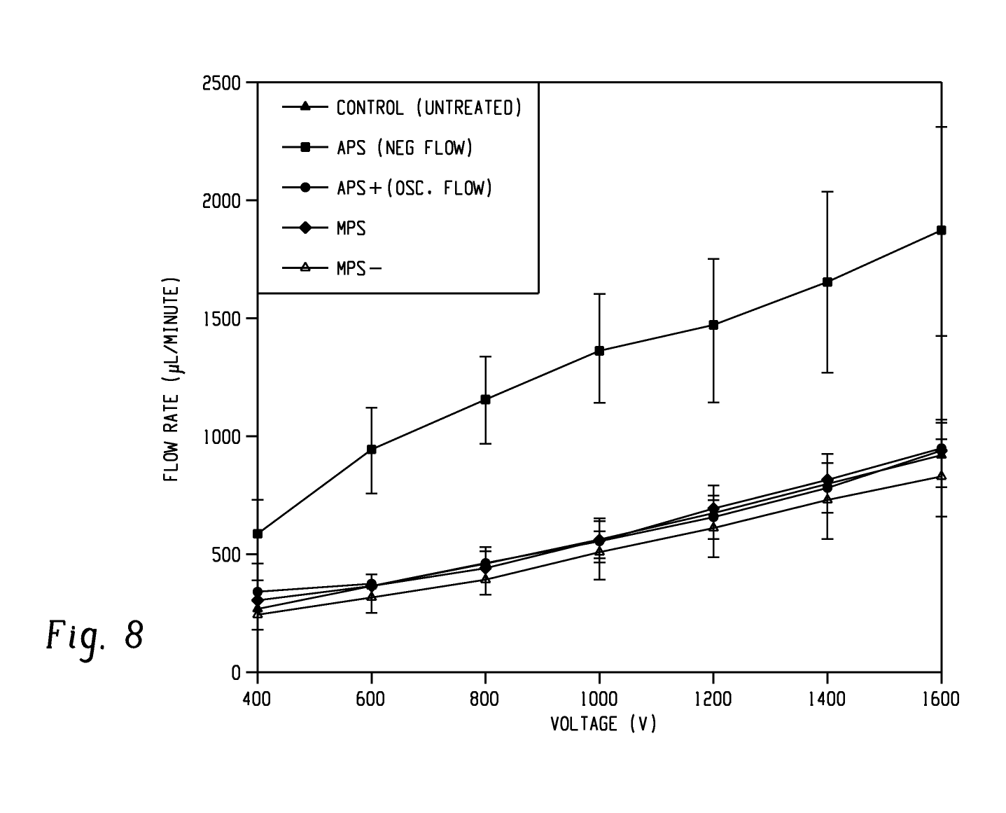

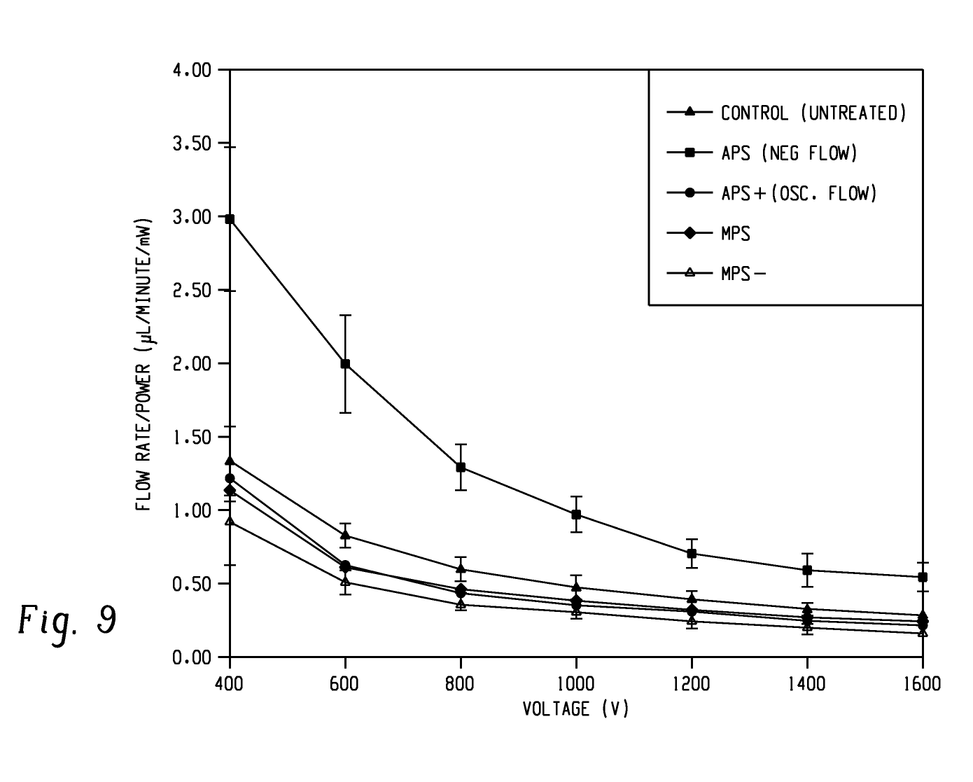

When tested under various voltages in the pump chamber, as described for Example 1, neither the thiol (MPS) or negatively charged sulfonate groups (MPS−) resulted in significant changes in flow rate or power efficiency, as illustrated in FIGS. 8 and 9.

When the filters containing amine functional groups on their surfaces were tested, the protonated amine surface (APS+) resulted in an oscillating flow that had a net flow rate and power efficiency similar to the control, untreated filters. However, the native amine surfaces (APS) resulted in a flow opposite in direction to the control filters, indicating that surface had a positive charge that was both significantly larger and more efficient in pumping than control filters (FIG. 9) at all voltages tested. While the amine groups of the APS filters were not expected to have a positive charge, the resulting reversal of flow direction indicated that they had acquired a positive charge, likely due to the applied electric field. The increase in power efficiency (as indicated by the flow rate/input power) at 400 volts was 127%, with the control filters moving 1.32 μl/min/mW and the APS treated filters moving 2.99 μl/min/mW.

### Example 4

### Effect of Filter Surface Area

In Examples 1 and 2, a filter surface area of 0.1 cm² and single wire platinum coated molybdenum electrodes were used. For this example, a larger filter area and grid electrodes were used. The grid electrodes were made of gold and shaped as illustrated in FIG. 2 with a 0.06 mm wire diameter, wires per inch=82×82, 0.25 mm aperture width, 65% open area, and 60 μm disk thickness. The chamber design was modified from that used with the wire electrode to accommodate the disk-shaped electrodes.

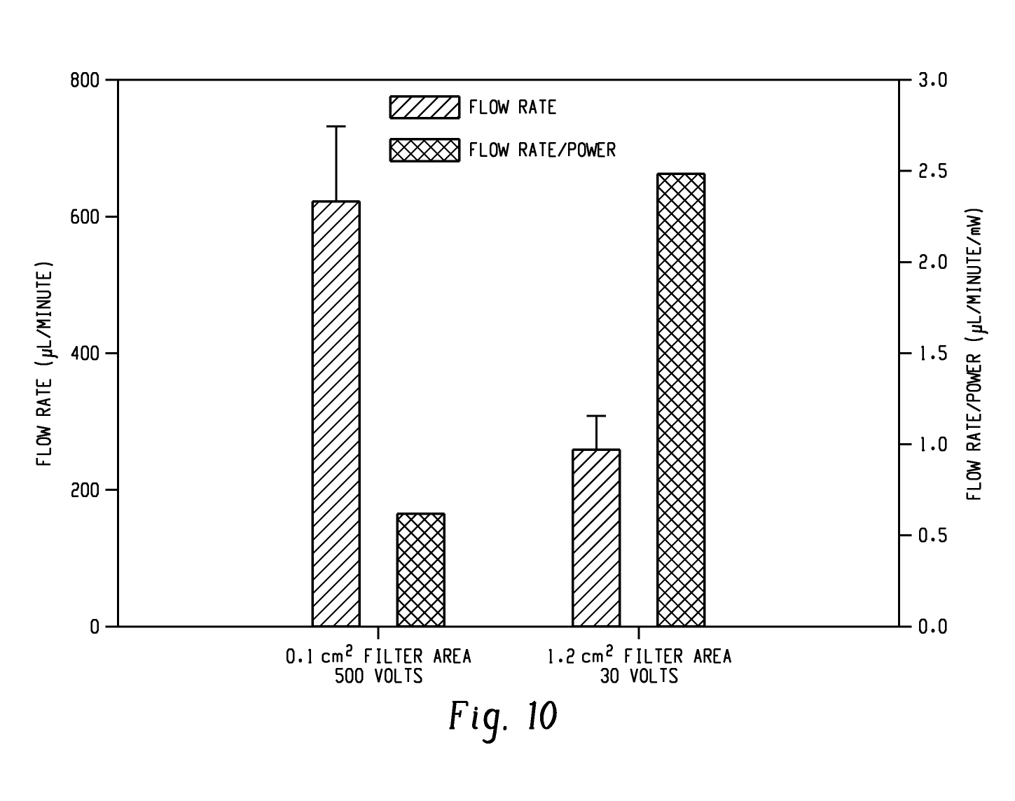

Increased surface area filters combined with the mesh electrodes resulted in increased efficiency at very low voltages. For example, when the filter surface area was increased to from 0.1 cm² to 1.2 cm² and the electrodes constructed of solid gold mesh, the pumping efficiency increased by approximately 5-fold (FIG. 10). The 1.2 cm² filter was run at 30 V versus 500 V for the 0.1 cm² filter. This was due to the limitations of the power supplies used. For the 0.1 cm² area filters, detectable flow (using the flow detection equipment used) occurs at about 200V, while reliable measurements occur at about 400V. The high voltage power supply used for the 0.1 cm² area filters could not source enough current for the 1.2 cm² filter at voltages that produced flow in the 0.1 cm² filter. The available low voltage/high current power supply maxed out at 30 V, but produced detectable flow at this voltage. The ability to produce flow at a low voltage is significant as many applications of the exemplary pump would be best implemented at low voltages for safety reasons.

### Example 5

### Reproducibility Studies

In order to determine the reproducibility of the functionalization process, the liquid sorption capacities of functionalized glass fiber filters were evaluated. This measurement also provides an indication of the hydrophobicity/hydrophilicity/oleophobicity of the filter following functionalization. Water and hexadecane were used as sorbates. Comparison of unmodified filters using this technique indicated that, on average, the Whatman GF series of filters absorbed more water than the Millipore APF series. The GF/D filters were found to be the most adsorbent. When the filters of Example 1 were modified using a silane with a hexane group. All of the filters showed reduced water sorption. Water sorption was found to decrease with increasing coverage by the alkane chain as expected. In particular, greater surface coverage by a hydrophobic group reduced the water adsorbed by the fibers. The greater surface coverage is achieved by using a higher weight % of the silane in the functionalization process. Similarly, increasing chain length or fluorine coverage decreased the sorption of water while addition of a hydrophilic group (i.e., the APS modifier) produced similar water sorption to that of the unmodified filter. Reduced hexadecane sorption was observed for increasing fluorine coverage (fluorine-saturated alkane chains of greater length) while varying the coverage of surfaces by alkane groups did not yield changes in its sorption. Using this method of evaluation, the functionalization process was determined to be highly reproducible.

### Example 6

### Effect of Membrane Thickness

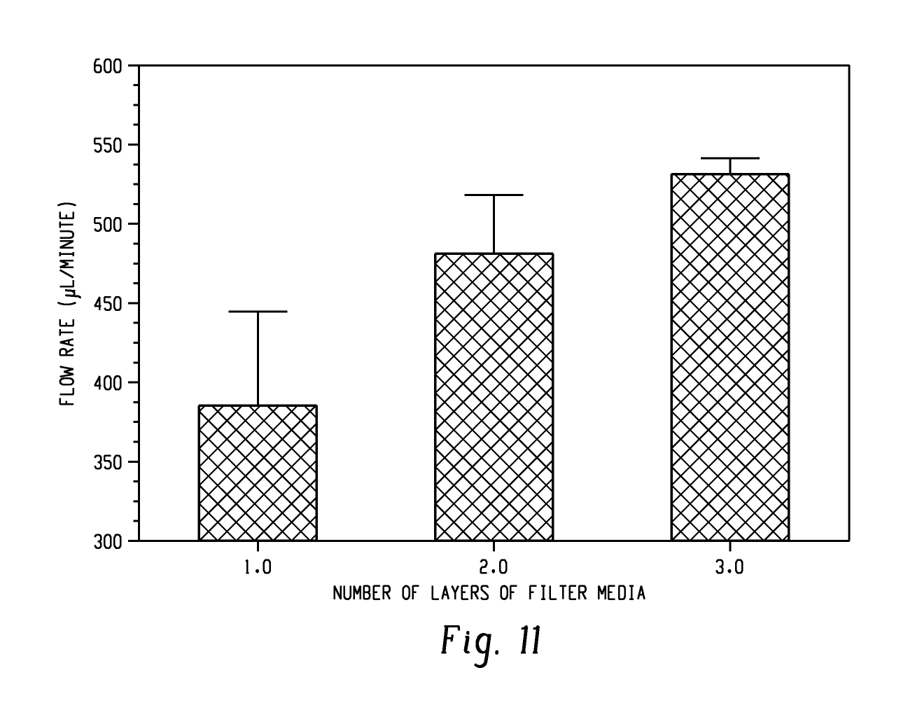

A study of the effect of membrane thickness was performed by using stacks of one, two and three Whatman GF/F filters (cleaned but unfuctionalized) in a pump with wire electrodes as described in Example 1 to provide membrane thicknesses of approximately 420 μm, 840 μm, and 1260 μm. As the membrane thickness increased from one to three filters in thickness, the flow rate (μl/min) of water through the membrane also increased as shown in FIG. 11, where the results are the average of 3 runs, showing the standard deviation above). The difference was most noticeable changing from one to two filters, suggesting that with more than three filters, the improvement may be small, if any. Measurements of efficiency showed this was unchanged with filter thickness. Pump head pressure increased with thickness.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An electroosmotic pump comprising:
first and second electrodes;
a membrane comprising inorganic oxide fibers intermediate the first and second electrodes; and
a source of a potential difference connected with the electrodes, which during operation of the pump, provides an electric field between the electrodes.

2. The electroosmotic pump of claim 1, wherein the inorganic oxide fibers comprise at least one of silica, alumina, and zirconia.

3. The electroosmotic pump of claim 3, wherein the fibers of the membrane comprise at least 60 wt. % silica.

4. The electroosmotic pump of claim 1, wherein the fibers are entangled in the membrane.

5. The electroosmotic pump of claim 1, wherein the electrodes each comprise a porous mesh.

6. The electroosmotic pump of claim 1, wherein the membrane and electrodes are flexible.

7. The electroosmotic pump of claim 1, wherein the membrane carries sufficient charge to cause a liquid in the pump to flow through the membrane.

8. The electroosmotic pump of claim 1, wherein surfaces of the fibers are functionalized to modify a charge on the oxide fibers.

9. The electroosmotic pump of claim 1, wherein the fibers are surface functionalized through reaction with a silane derivative.

10. The electroosmotic pump of claim 9, wherein the silane derivative comprises a trialkoxysilane.

11. The electroosmotic pump of claim 10, wherein the trialkoxysilane comprises a functional group selected from alkyl, alkenyl, methacrylate, and substituted derivatives thereof.

12. The electroosmotic pump of claim 8, wherein the pump has an efficiency measured as
$$\frac{flow rate}{power consumed} ,$$
which is at least 10% greater than a flow rate of the pump without functionalization.

13. The electroosmotic pump of claim 1, further comprising a liquid-receiving chamber in which the electrodes and membrane are disposed, whereby during operation, the liquid flows through the membrane from a region of the chamber adjacent the first electrode to a region of the chamber adjacent the second electrode.

14. The electroosmotic pump of claim 1, having no moving parts.

15. A filtration system comprising a partially permeable membrane and the electroosmotic pump of claim 1, the pump positioned to draw liquid through the partially permeable membrane.

16. An article of clothing comprising a fabric layer and the electroosmotic pump of claim 1 positioned to draw liquid through the fabric layer.

17. A membrane for an electroosmotic pump comprising inorganic oxide fibers functionalized with a silane derivative.

18. A method for forming an electroosmotic pump comprising:
disposing a membrane comprising inorganic oxide fibers between first and second electrodes; and
connecting a source of electrical potential to the electrodes, whereby a polar liquid in contact with one of the electrodes is drawn through the membrane by a charge on the membrane.

19. The method of claim 18, wherein the fibers are in the form of a porous filter.

20. The method of claim 18, wherein the fibers are surface-functionalized.

21. The method of claim 20, further comprising functionalizing the inorganic oxide fibers by contacting the fibers with a silane derivative in solution capable of reacting with a surface of the fibers.

22. The method of claim 21, wherein the silane derivative is present in the solution at a concentration of at least 0.1 wt %.

23. A method of pumping a polar liquid with the electroosmotic pump of claim 1, comprising:
applying a potential difference across the electrodes whereby the polar liquid is drawn through the membrane.

24. A method of filtering a polar liquid with a filtering system comprising the electroosmotic pump of claim 1 and a partially permeable membrane adjacent the pump, comprising:
applying a potential difference across the electrodes whereby a polar liquid is drawn through the partially permeable membrane to filter species from the polar liquid and then through the membrane of the electroosmotic pump.
